(19) United States
(12) Patent Application Publication
(10) Pub. No.: US 2015/0024674 A1
(43) Pub. Date: Jan. 22, 2015

(54) Agricultural frost protection using induction fans

(71) Applicant: Michael McGregor, Porterville, CA (US)

(72) Inventor: Michael McGregor, Porterville, CA (US)

(21) Appl. No.: 13/987,389

(22) Filed: Jul. 18, 2013

(51) Int. Cl. A01G 13/08

(52) U.S. Cl. CPC A01G 13/08
USPC 454/258; 454/284

(57) ABSTRACT

A system for protecting an agricultural field from frost damage, comprising: one or more induced flow apparatuses, each comprising an induced flow fan that has a primary air flow inlet, a primary air flow outlet, a secondary flow inlet and a secondary flow outlet wherein said primary air flow induces a larger volume of secondary air flow; a primary air flow impeller, powered by a motor, and a duct arrayed to conduct the primary flow from the primary flow impeller to the induced flow fan. The induced flow apparatuses are disposed to induce the flow of warmer, upper-level, air into a lower level, displacing lower, cooler, air in an agricultural field.

### RELATED U.S. PATENT APPLICATION

This application claims priority from, Provisional U.S. Patent application: Ser. No. 61/741,464, entitled “AGRICULTURAL FROST PROTECTION USING INDUCTION FANS,” filed Jul. 18, 2012. The referenced Provisional U.S. patent application is hereby incorporated herein by reference in its entirety.

### BACKGROUND OF THE INVENTION

The production of citrus is a worldwide industry worth many billions of dollars. Much of the world supply of citrus fruit is cultivated in the sub-tropical regions of the Earth's temperate zones and many of the prime citrus growing areas, though not subject to severe winters, are subject to occasional freezing.

Citrus varieties harvested in winter, such as California's famous oranges and lemons, are prone to frost damage and must be protected from the occasional light frost endemic to some citrus growing regions. Frost protection is a major cost of citrus production.

Protection from frost is critical. Most citrus will freeze when fruit temperature drops to 27-28° F. The main methods of frost protection in California and similar growing regions, such as Arizona, are by wind and water.

Water application allows for heat built up in the soil during the day to be lost more slowly, and air temperatures around the fruit stay warm a little longer. The temperature ranges of effective water usage are limited and, since the frost protection is most critical as the fruit nears harvestability, a wet orchard can inhibit harvesting access.

Wind machines, large fans on structures extending above the grove's tree tops and above the temperature inversion that forms on frosty nights, are used to force warmer inversion air above the orchard down to tree level, warming the fruit. The machines, whose large propellers are typically powered by stationary diesel engines, are turned on when the temperatures near freezing. The fans mix the slightly warmer air above the grove with the colder air near the ground, warming the area around the trees.

A few growers use oil-burning orchard heaters, but this once common method is seldom used now because of the enormous cost in fuel and labor, because of the limited effectiveness of the practice, and because of its attendant pollution.

Wind machines tend to be very popular in growing areas characterized by valley floors where temperature inversions are common during freezes. In these areas, it is not uncommon to see many machines in larger groves, population densities of machines approximating one for every five to ten acres.

However effective they may be, wind machines are very expensive to purchase, operate and maintain. They require year-long maintenance and, during periods of nightly frosts, they require frequent refueling. The location of the machines, isolated from each other and from constant supervision, makes the fuel in their tanks an attractive target for fuel thieves. Additionally, in order to reduce the necessary maintenance of a wind machine that is performed well above ground level, some wind machines have their engines located at ground level, with the propeller being powered through a system of drive shafts and gearing. This additional complexity results in more rapid wear and more frequent breakage which incurs additional expense. Furthermore, wind machines in groves adjacent to residential areas cause significant noise nuisance and, in some instances, birds have been killed by the rotating propellers.

Propeller-driven wind machines also are very inefficient. Such machines, lose much of their energy to moving their propeller blades through essentially all of the air moved by the machine. Because of the efficiency losses of propellers, the equivalent energy input, through fuel or electricity, can be as much as five times the energy output in the form of moving air. The air so moved is also very turbulent due to the rotating action of the propeller blades, resulting in energy being expended to rotate the air mass, in addition to moving it toward the crops needing frost protection.

### SUMMARY OF THE INVENTION

The present invention provides a method and apparatus for protecting agricultural crops from frost damage by the use of induction flow fans.

A system for protecting an agricultural field from frost damage, comprising: one or more induced flow devices, each comprising an induced flow fan that has a primary air flow inlet, a primary air flow outlet, a secondary flow inlet and a secondary flow outlet wherein said primary air flow induces a larger volume of secondary air flow; a primary air flow impellor, powered by a motor, and a duct arrayed to conduct the primary flow from the primary flow impellor to the induced flow fan. The induced flow devices, commonly of a type known as bladeless fans, are disposed to induce the flow of warmer, upper-level, air into a lower level, displacing cooler air in an agricultural field.

These and other objects and advantages of the present invention will become obvious to those of ordinary skill in the art after having read the following detailed description of the preferred embodiments which are illustrated in the various drawing figures.

### BRIEF DESCRIPTION OF THE DRAWINGS

FIG. 1 illustrates a method of agricultural frost protection using induced flow fans in accordance with an embodiment of the present invention.

FIG. 2 illustrates an apparatus for agricultural frost protection using induction fans in accordance with an embodiment of the present invention.

FIG. 3 illustrates an apparatus for agricultural frost protection in accordance with an embodiment of the present invention.

FIG. 4 illustrates an overhead view of a system for agricultural frost protection using an induction fan in accordance with an embodiment of the present invention.

FIG. 5 illustrates an overhead view of a system for agricultural frost protection using a plurality of induction fans in an orchard in accordance with an embodiment of the present invention.

FIG. 6 illustrates an apparatus for inducing air flow for agricultural frost protection in accordance with an embodiment of the present invention.

FIG. 7 illustrates an apparatus for inducing air flow for agricultural frost protection in accordance with an embodiment of the present invention.

FIG. 8 illustrates a cross section of a flow nozzle in an apparatus for inducing air flow for agricultural frost protection in accordance with an embodiment of the present invention.

### DETAILED DESCRIPTION

Reference will now be made in detail to embodiments of the present invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description, numerous specific details are set forth in order to provide a thorough understanding of the present invention. However, it should be understood by one of ordinary skill in the art that the present invention may be practiced without these specific details. In other instances, well-known methods, procedures, components, and circuits have not been described in detail so as not to unnecessarily obscure aspects of the present invention. At times, concepts disclosed in this discussion of embodiments of the present invention will be made more readily apparent by reference to the Figures.

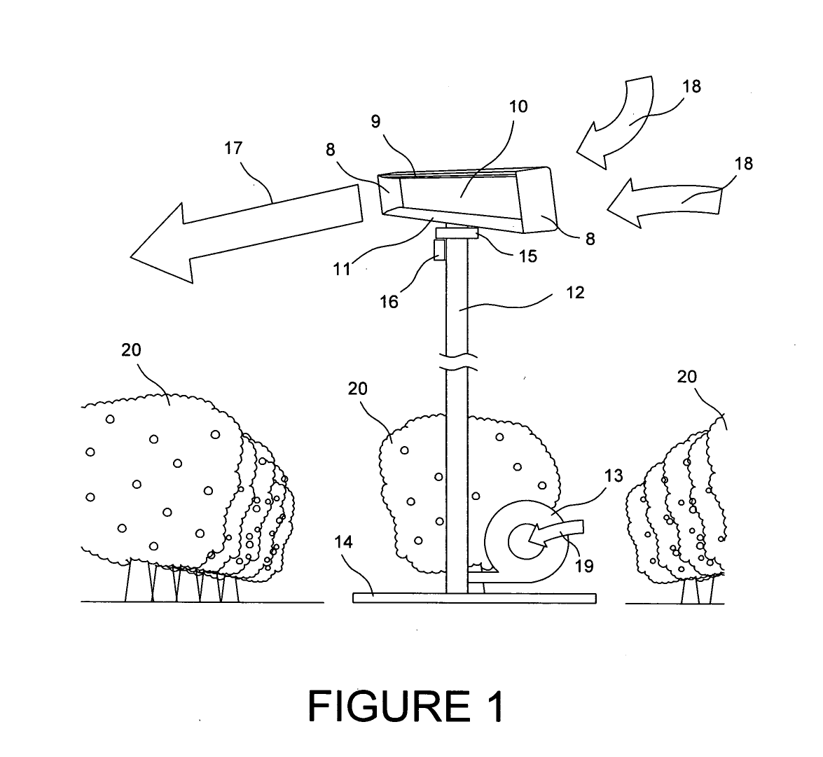

Presented herein is a system for protecting an agricultural field from frost damage. The system comprises one or more bladeless fans for moving air in the manner needed to protect agricultural crops from freezing air, in accordance with common practice for displacing colder air in an inversion with warmer air from higher levels. Embodiments of the present invention use induced flow technology in a novel fashion to provide that frost protection of vulnerable crops. One embodiment of the present invention, utilizing bladeless induction fans to displace relatively cool air in the vicinity of a vulnerable crop with relatively warmer air from above, is illustrated in FIG. 1.

FIG. 1 illustrates an air moving apparatus, in this embodiment, a bladeless fan, used in one embodiment, similar to a type of common household bladeless cooling fan, situated in an orange grove to provide frost protection. The bladeless induction fan has a flow inducing device that comprises a primary air flow inlet 19, connected by a duct to a primary air flow outlet, a secondary flow inlet and a secondary flow outlet wherein the primary air flow is enabled to induce a larger volume of secondary air flow. In this embodiment, the primary air flow 19 is provided by a primary air flow impeller 13, comprising a motor and a fan, which moves relatively high pressure primary air through a duct 12 which is arrayed to conduct the primary air flow from the primary flow impellor to the primary flow inlet. Duct 12 and impeller 13 are, in this embodiment, a electric motor and fan mounted on a base 14 which is enabled to provide support and stability to the entire apparatus. In another embodiment, the impeller 13 is powered by a combustion engine.

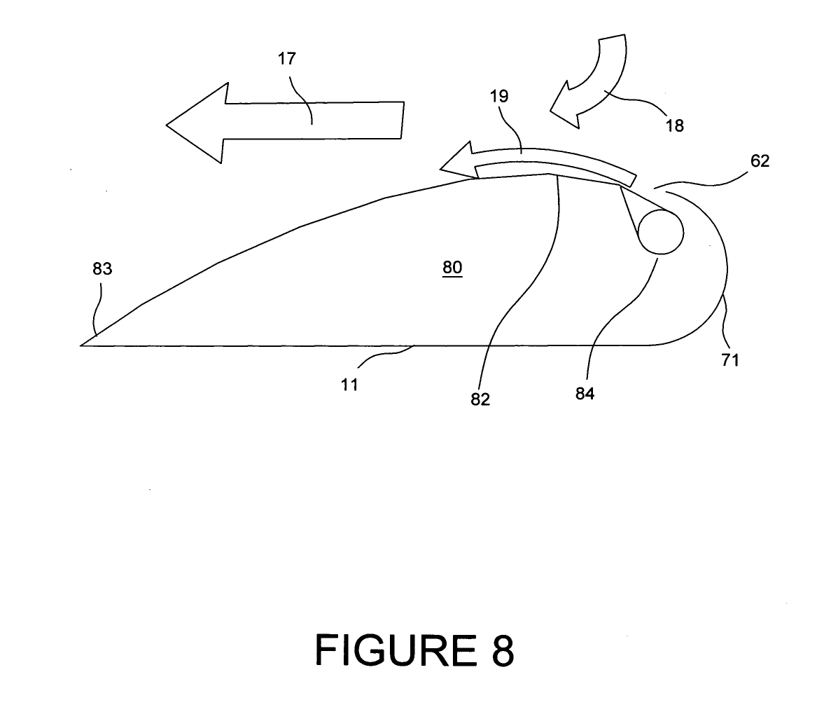

A duct in the induced flow duct 10 allows the primary air to exit the duct through a slot (81 in FIG. 8) in the housing such that the primary air induces secondary air flow 18 from the vicinity of the secondary flow inlet to induced flow duct 10. The combination of primary and secondary air flow results in a total airflow 17 which, because secondary flow 18 is drawn from a region of warmer air, results in the warming and frost protection of agricultural crop 20. In this embodiment, the agricultural crop is illustrated as oranges. In other embodiments, the protected crop is grapes, strawberries, or other frost-sensitive agricultural products.

In another embodiment, the duct 12 functions as support structure or stanchion for the induced flow fan housing 11. It is noted here that, in an embodiment of the present invention, the warm total air flow 17 is directed by the pointing of the induced flow housing 11. In addition to downward deflection, five to eight degrees in one embodiment, consistent with prior art propeller-driven machines, the housing is enabled to rotate about a vertical axis on a slewing bearing 15 which, in this embodiment, is powered by motor 16. The action of motor 16 and slewing bearing 15 serves to direct total air flow 17 over 360 degrees, enabling the coverage of a relatively large area. In prior art implementations of propeller-based warming fans, the coverage area can be on the order of 5-10 acres. In one embodiment of the present invention, the ground level cool air is displaced by warmer air up to a distance of nearly 400 feet, encompassing an area of more than 10 acres.

It is noted here that, in another embodiment, not shown, a primary air inlet duct provides primary air flow 19 to be drawn from the warmer region supplying secondary air 18. This duct lies, in this embodiment, essentially parallel to duct/station 12 but is not directly connected to it.

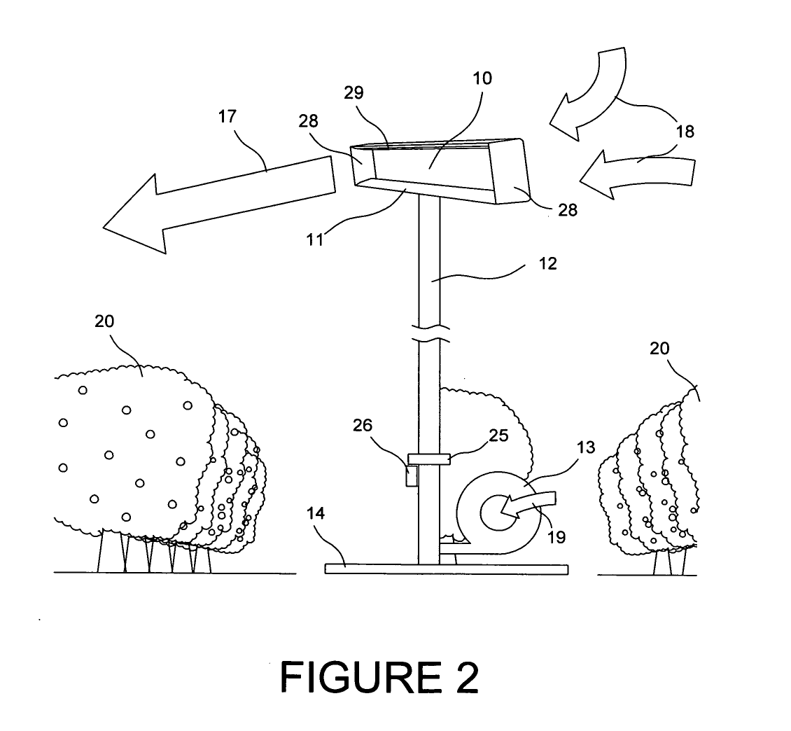

FIG. 2 illustrates another embodiment of the present invention. IN FIG. 2, slewing bearing 25 and motor 26 are located near ground level. This embodiment, enabled by the use of a robust crane-type bearing as slewing bearing 25, allows all maintenance functions necessary to the apparatus of FIG. 2 to be performed at ground level. This obviates the need for ladders or cherry-pickers to gain access to workers performing the maintenance. Ground level maintenance also reduces risk to workers compared to that performed at the upper level, in one embodiment as high as 50 feet above ground level.

Because of the nature of induced flow fans as shown in these illustrations of the present invention, the cost of operation of crop protection fans can be much lower that of the prior art propeller-based fans. Most especially, the energy cost of running a crop protection fan, which can be thousands of dollars in a single season, is much reduced. This is due to the inherent efficiency of induced flow.

In both the embodiments illustrated here, the only moving part above the slewing bearing is the duct/stanchion 12 and the induced flow fan housing 11. This provides the significant advantages over prior art of reduced mechanical complexity which results in a reduced cost of maintenance as well as a potentially reduced acquisition cost. Furthermore, by providing non-moving means of inducing airflow, potential bird-strikes/injuries are significantly reduced and, significantly, environmental noise of operation is very much reduced. This allows growers to more aggressively protect their crops while remaining good neighbors and good stewards of the land.

It is also noted here that induced flow housing 10, shown in both FIGS. 1 and 2, is essentially rectangular in shape. This shape derives, in the embodiment of FIG. 1, from a lower flow nozzle 11 being disposed essentially parallel to upper flow nozzle 9. Having two nozzles with slots (81 in FIG. 8) allows for a robust distribution of primary air flow 19. Primary air flow 19 is fed to upper flow nozzle 9 via support ducts 8.

In the embodiment illustrated in FIG. 2, only lower flow nozzle 11 has a primary flow outlet slot 81. Upper panel 29 and supports 28 are essentially inert. It is noted here that, in one embodiment, the inner surfaces of induced flow duct 10 are shaped much like an airfoil. This shaping enhances the venturi effect that induces secondary flow 18. In another embodiment, the inner surfaces are flat, enabling a less costly manufacturing process for induced flow duct 10.

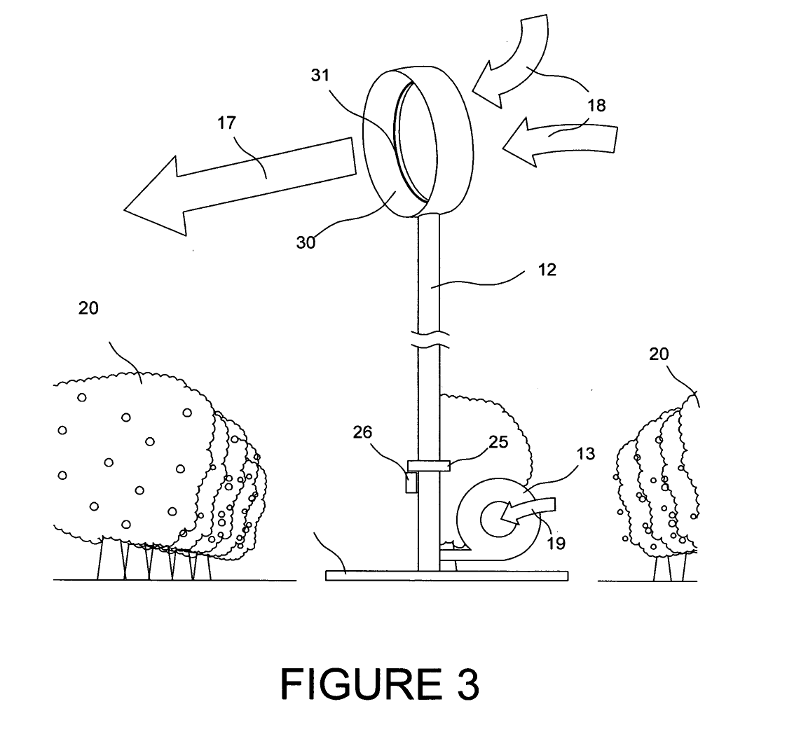

FIG. 3 illustrates an apparatus for agricultural frost protection in accordance with an embodiment of the present invention in which the induced flow ducting 30 is oval in shape. In this embodiment, the cross section of the structural ring of induced flow is similar to the cross sectional shape of rectangular induced flow duct 10 in FIGS. 1 and 2. Primary flow outlet slot 31 in this embodiment encircles the secondary flow duct. It is noted that, in one embodiment, the area ratio of primary flow outlet slot 31 to secondary idlow duct 30 is less than 0.1.

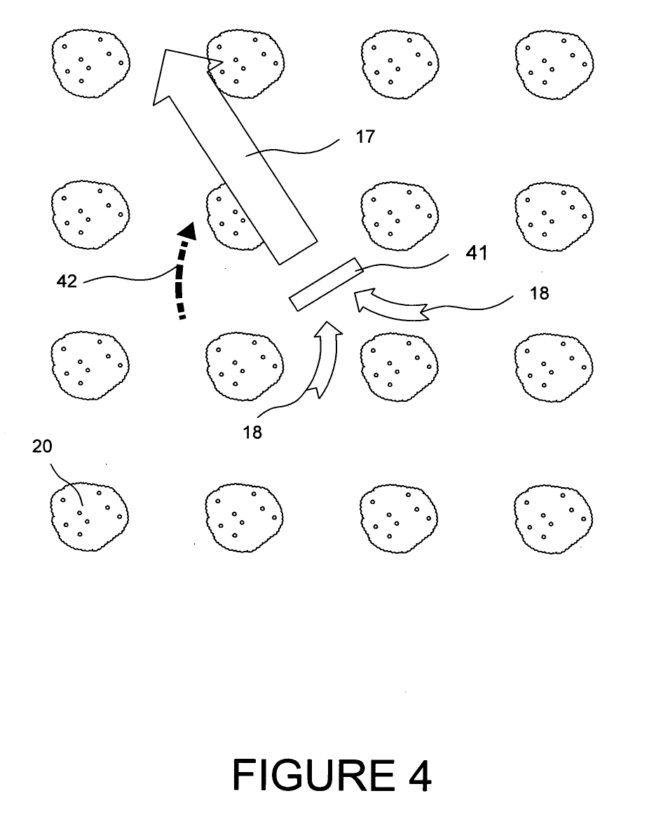

FIG. 4 illustrates an overhead view of a system for agricultural frost protection using an induction fan in accordance with an embodiment of the present invention. In this embodiment, an agricultural crop 20, here for the sake of illustration shown as an orange grove, has a deployed induced flow apparatus 41 for the purpose of frost protection. Induced flow apparatus 41 induces warm secondary air 18 into total flow 17. The flow 17 is able, by being directed slightly downward, to warm the orange trees 20 out to a distance from the base of as much 300 to 400 feet. By being able to rotate 42 around a vertical axis, induced flow apparatus 41 is enabled to warm an area of as much as ten acres.

It is also noted here that, because flow 17 is less turbulent that prior art propeller-driven machines, damage to crops from excessive flow can be avoided at higher primary velocities when using embodiments of the present invention. This can enable higher primary velocities, resulting in a warming coverage greater than that afforded by the equivalent prior art machine.

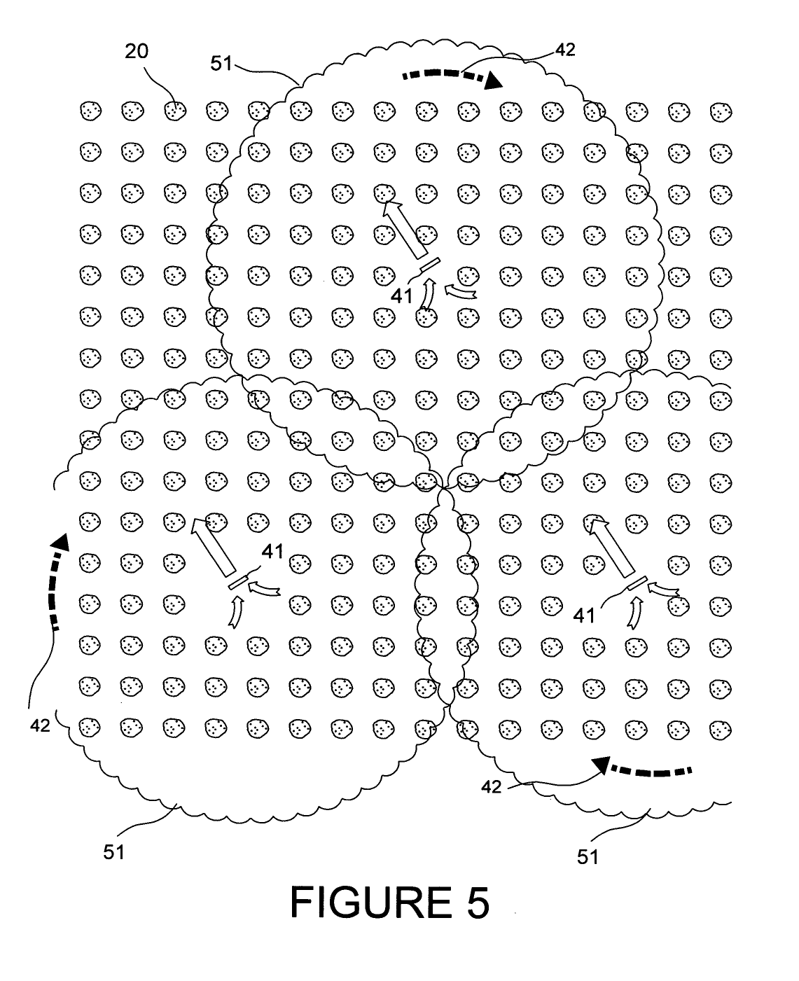

FIG. 5 illustrates an overhead view of a system for agricultural frost protection using a plurality of inducted flow apparatuses in an agricultural crop 20 in accordance with an embodiment of the present invention. In this embodiment, warming coverage 51 of each induced flow apparatus 41 allows a deployment of multiple induced flow apparatuses 41 such that coverages 51 overlap, providing complete coverage of the entire crop. In one embodiment wherein a plurality of induced flow apparatuses are deployed, the apparatuses commence operation on a signal from an automatic system that can read salient information such as temperature, humidity, overcast coverage, etc.

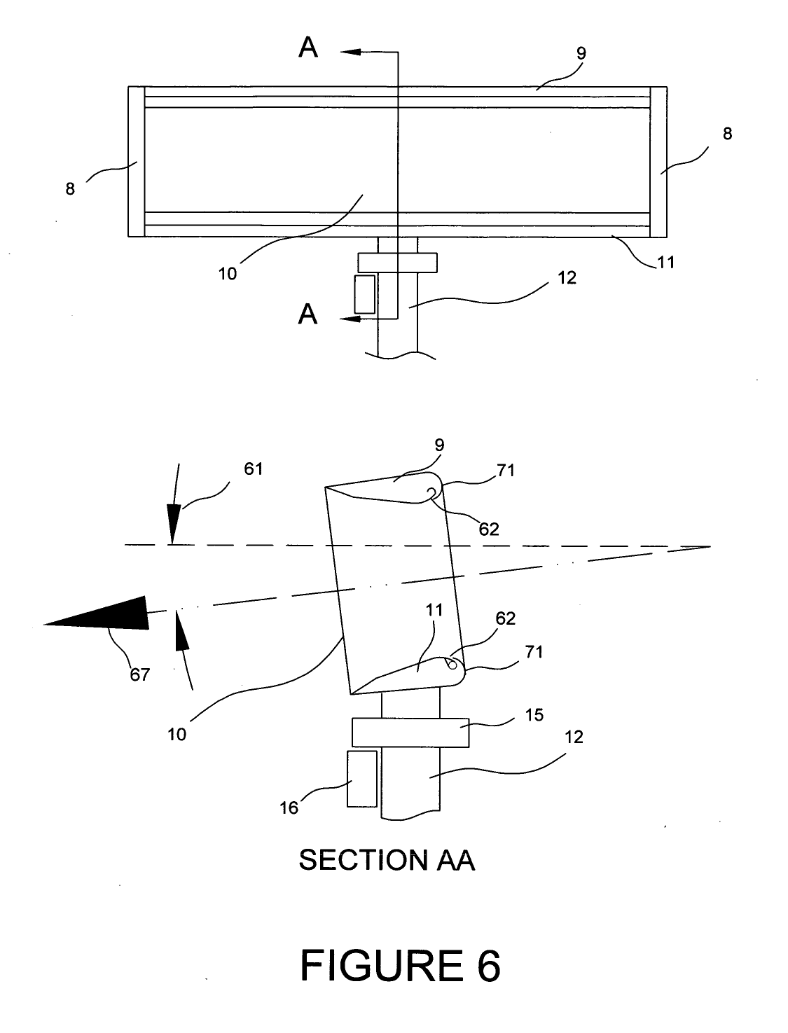

FIG. 6 illustrates some details of an apparatus for inducing air flow for agricultural frost protection in accordance with an embodiment of the present invention, similar to the embodiment illustrated in FIG. 1. In this illustration, induced flow duct 10 is essentially rectangular, with lower flow nozzle 11 and upper flow nozzle 9 forming the horizontal sides and vertical ducting 8 forming each end. Primary air flow, 19 in FIGS. 1, 2 and 3, is carried to induced flow duct 10 by duct/station 12. Primary air flow 19 enters flow nozzles 11 and 9, then exits primary flow outlet slot 62. In this embodiment, primary flow 19 travels at a relatively high speed over the inner surfaces of lower and upper flow nozzles 11 and 9, inducing secondary air flow, 18 in FIGS. 1, 2 and 3, into induced flow duct 10 and combining to form total air flow, 17 in FIGS. 1, 2 and 3.

In this illustration, slewing bearing 15 and slewing motor 16 are shown, for the purpose of illustration, as being close to the underside of induced flow duct 10. In another embodiment, slewing bearing 15 and slewing motor 16 are near ground level. In such an embodiment, there can be a higher moment load on slewing bearing 15 due to wind gusts on induced flow duct 10 and the length of duct/stanchion 12. Slewing bearing 15 enables these moment loads by being of a very robust type associated with the slewing bearings of cranes and excavators. Slewing motor 16 is geared to slewing bearing 15, in this embodiment, much in the way such motors are enabled in cranes and excavators.

Also illustrated in FIG. 6 is the induced flow duct depression angle 61 of the total flow axis 67. In one embodiment, this angle is between 5 and eight degrees. In another embodiment, the depression angle 61 is seven degrees.

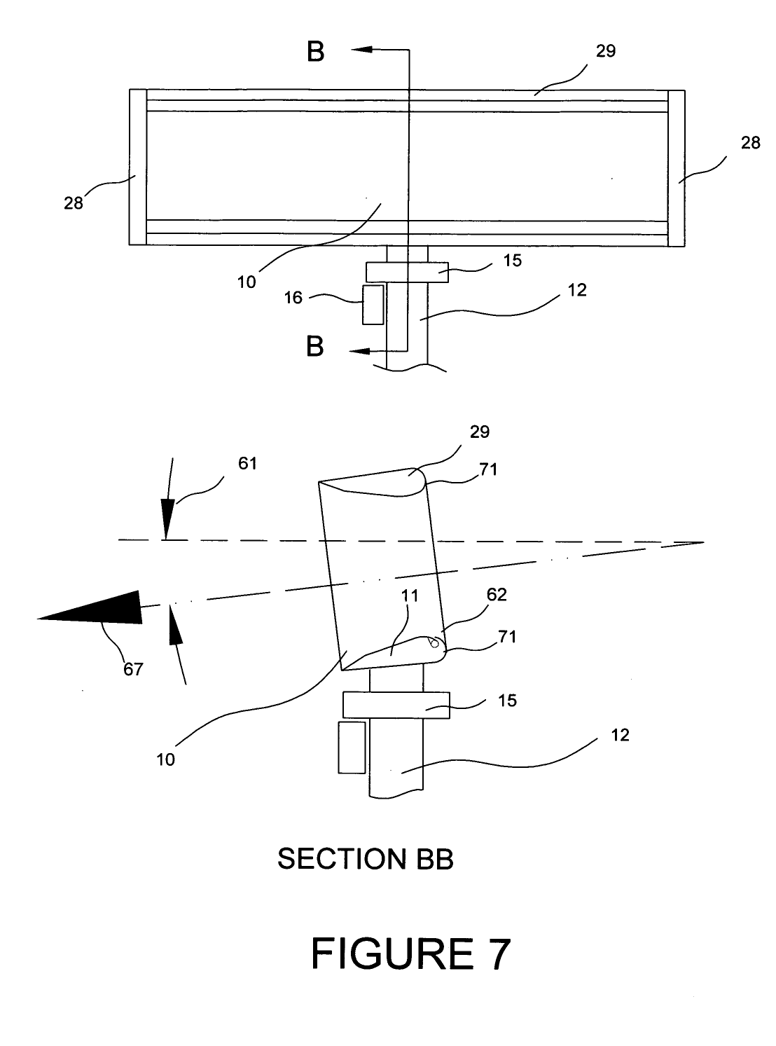

FIG. 7 illustrates an apparatus for inducing air flow for agricultural frost protection in accordance with an embodiment of the present invention. Here, some details of embodiment of the induced flow duct shown in FIG. 2 are illustrated. In this embodiment, upper flow nozzle 9 is replaced by upper duct member 29 which is, in essence, inert, meaning it does not have a primary air flow outlet slot such as slot 62, found in lower flow nozzle 11.

It is noted here that, in both duct embodiments shown here, secondary air flow enters induced flow duct 10 past rounded leading edges 71 of the upper and lower flow nozzles 9 and 11 and structural members 28 and 29. The rounded leading edges allow the maintenance of laminar flow for a longer time on entry into duct 10, reducing the downstream turbulence of total flow 17 which can be associated with some crop damage.

FIG. 8 illustrates a cross section of a flow nozzle in an apparatus for inducing air flow for agricultural frost protection, in accordance with an embodiment of the present invention. In this illustration, an embodiment of lower flow nozzle 11 is shown. Lower flow nozzle 11 has duct plenum 80, upper surface 82, rounded leading edge 71, trailing edge 83, rounded internal edge 84, and primary flow outlet slot 62. Primary air flow 19 arrives through duct plenum 80, passes around rounded edge 84, and exits through primary flow outlet slot 62. As primary flow outlet slot 62, in this embodiment, is narrow, primary air flow 19 passes over upper surface 82 at a relatively high speed. This serves to aid the inducement of induced secondary air flow 18 and entrain it into induced flow duct 10, forming total air flow 17. This is aided by the Bernoulli effect of the primary air flow 19 as it passes over upper surface 82, meaning a reduction in static pressure, serving to enhance the entrainment of secondary air flow 18.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

The invention claimed is:

1. A system for protecting an agricultural field from frost damage, said system comprising:
an air moving apparatus, said air moving apparatus comprising;
an air moving device comprising: a primary air flow inlet, a primary air flow outlet, a secondary flow inlet and a secondary flow outlet wherein said primary air flow induces a secondary air flow, said secondary air flow being of a larger volume than said primary air flow;
a primary air flow impellor comprising a motor and a fan; and
a duct arrayed to conduct said primary flow from said primary flow impellor to said primary flow outlet;
wherein said air moving apparatus is disposed to move air through an agricultural field and wherein moving said air results in a warming of an agricultural crop in said agricultural field.

2. The system for protecting an agricultural field from frost damage described in claim 1, wherein said air moving apparatus comprises a bladeless fan.

3. The system for protecting an agricultural field from frost damage described in claim 2, wherein said bladeless is fan essentially rectangular in shape.

4. The system for protecting an agricultural field from frost damage described in claim 2, wherein said bladeless fan is essentially oval in shape.

5. The system for protecting an agricultural field from frost damage described in claim 1, wherein said primary air flow is directed over a surface, wherein directing said air flow over said surface results in a reduction in static pressure in said air flow and said reduction in static pressure induces said secondary air flow.

6. The system for protecting an agricultural field from frost damage described in claim 1, wherein said air flow induction device is an air induction nozzle.

7. The system for protecting an agricultural field from frost damage described in claim 1, wherein said secondary air flow is induced from a region above the ground in which the air is warmer than the air lying closer to the ground.

8. The system for protecting an agricultural field from frost damage described in claim 1, wherein said system comprises a plurality of air flow induction devices, said air flow induction devices being arrayed to provide warmer air to essentially all of said agricultural crop in said agricultural field.

9. A method for protecting an agricultural field from frost damage, said method comprising:
learning that the air temperature in said agricultural field is lowering to a point of potential frost damage to the crop in said agricultural field; and
upon said learning, deploying an air flow inducing device to induce the flow of warmer air into proximate contact with said agricultural crop, wherein said air flow inducing device is of a type known as an air flow induction device and wherein said proximate contact with said warmer air results in protecting said agricultural crop from said potential frost damage.

10. The method for protecting an agricultural field from frost damage described in claim 1, wherein said air moving apparatus comprises a bladeless fan.

11. The method for protecting an agricultural field from frost damage described in claim 2, wherein said bladeless is fan essentially rectangular in shape.

12. The method for protecting an agricultural field from frost damage described in claim 2, wherein said bladeless fan is essentially oval in shape.

13. The method for protecting an agricultural field from frost damage described in claim 1, wherein said primary air flow is directed over a surface, wherein directing said air flow over said surface results in a reduction in static pressure in said air flow and said reduction in static pressure induces said secondary air flow.

14. The method for protecting an agricultural field from frost damage described in claim 1, wherein said secondary air flow is induced from a region above the ground in which the air is warmer than the air lying closer to the ground.

15. The method for protecting an agricultural field from frost damage described in claim 1, wherein said method employs system comprising a plurality of air flow induction devices, said air flow induction devices being arrayed to provide warmer air to essentially all of said agricultural crop in said agricultural field.

16. The method for protecting an agricultural field from frost damage described in claim 1, wherein said deploying said air flow inducing device to induce the flow of warmer air into proximate contact with said agricultural crop is accomplished by means of an automated system.

17. An apparatus for protecting an agricultural field from frost damage, said apparatus comprising:
an air moving element, said air moving element comprising;
an air moving device comprising: a primary air flow inlet, a primary air flow outlet, a secondary flow inlet and a secondary flow outlet wherein said primary air flow induces a secondary air flow, said secondary air flow being of a larger volume than said primary air flow;
a primary air flow impellor comprising a motor and a fan; and
a duct arrayed to conduct said primary flow from said primary flow impellor to said primary flow outlet;
wherein said air moving element is disposed to move air through an agricultural field and wherein moving said air results in a warming of an agricultural crop in said agricultural field.

18. The apparatus for protecting an agricultural field from frost damage described in claim 17, wherein said air moving element comprises a bladeless fan.

19. The apparatus for protecting an agricultural field from frost damage described in claim 18, wherein said bladeless is fan essentially rectangular in shape.

20. The apparatus for protecting an agricultural field from frost damage described in claim 17, wherein said secondary air flow is induced from a region above the ground in which the air is warmer than the air lying closer to the ground.
